(19) United States
(12) Patent Application Publication
(10) Pub. No.: US 2016/0252051 A1
(43) Pub. Date: Sep. 1, 2016

(54) BUBBLE COLLECTOR FOR SUCTION FUEL SYSTEM

(71) Applicant: Sikorsky Aircraft Corporation, Stratford, CT (US)

(72) Inventors: David R. Smith, West Haven, CT (US); Daniel John Shields, Derby, CT (US)

(73) Assignee: Sikorsky Aircraft Corporation, Stratford, CT (US)

(21) Appl. No.: 14/098,587

(22) Filed: Dec. 6, 2013

(51) Int. Cl. F02M 25/08; B64D 37/00; B64C 27/00; F02M 37/02

(52) U.S. Cl. CPC F02M 25/0872; F02M 37/02; F02M 25/089; B64D 37/005; B64C 27/00

(57) ABSTRACT

A fuel feed system for a rotary-winged aircraft includes a fuel feed line extending from a fuel source to an engine and an engine fuel suction pump disposed at the fuel feed line to urge a flow of fuel through the fuel feed line to the engine. A collector is located along the fuel feed line between the fuel source and the engine to collect air-vapor bubbles which form in the flow of fuel. An air-vapor line extends from the top of the collector and merges with the fuel line section between the collector and the engine fuel pump. The air-vapor line is sized and configured to limit the flow of air-vapor from the collector to the engine fuel suction pump to a rate which the engine fuel suction pump can tolerate.

### FEDERAL RESEARCH STATEMENT

This invention was made with government support under contract number N00019-06-C-0081 awarded by the United States Navy. The government has certain rights in the invention.

### BACKGROUND

The subject matter disclosed herein relates to aircraft. More specifically, the subject matter disclosed herein relates to suction fuel feed systems for aircraft.

Aircraft, for example, helicopters, include fuel feed systems having fuel lines and plumbing components which carry fuel from the fuel tanks to the engines. In modern helicopters, the engines are typically mounted higher up than the fuel tanks. Suction type engine fuel feed systems utilize a suction pump mounted on the engine which draws fuel up from the fuel tank. Suction type fuel feed systems are used in many helicopters because of the safety they provide. In the event of a fuel feed line leak, such as a rupture due to ballistic damage, air is drawn into the fuel line rather than fuel spraying out as would occur in a pressurized fuel system.

In a suction type fuel feed system, however, the suction acting on the fuel can cause air and fuel vapor dissolved in the fuel to come out of solution and form bubbles in the fuel as it travels up the fuel line to the engine fuel pump. The engine fuel pump has a maximum allowable vapor-to-liquid volume fraction (V/L) and a maximum allowable bubble size at the pump's fuel inlet which the pump can tolerate, beyond which, the fuel pump will lose its priming and stop pumping fuel, resulting in engine flame-out.

Engine fuel feed lines are generally designed to limit the fuel line pressure drop such that the calculated V/L ratio at the engine fuel pump inlet, based on the worst case combinations of altitude, fuel type, fuel pressure, fuel temperature, and aircraft g loading, is limited to the level the engine fuel pump can tolerate. The calculated V/L ratio represents a time-averaged value of the ratio of air-vapor volume to liquid fuel volume entering the engine fuel pump. However, constraints on the fuel line sizing and routing imposed by the helicopter configuration can cause occasional or periodic local concentrations of bubbles in the fuel line which are larger than the maximum bubble size that the engine pump can tolerate even when the overall time-averaged V/L ratio determined based on altitude, fuel type, fuel pressure, and fuel temperature is within the engine fuel pump limit.

A possible cause of a periodic accumulation of a large amount of air and fuel vapor at the engine fuel pump's fuel inlet is operation of the helicopter at conditions in which the fuel velocity in the fuel feed line is lower than the natural velocity at which a bubble would rise upward in the fuel line due to buoyancy (the “bubble rise velocity”). This situation is generally the result of sizing the fuel feed line diameter to meet the calculated pressure drop limit associated with the fuel pump's V/L limit at the maximum fuel flow, altitude, and maneuvering g level. The diameter and flow area of the fuel line needed to meet the allowable fuel line pressure drop for a given fuel line geometry can result in fuel velocities below the bubble rise velocity, particularly at low fuel flows. Over time, the volumes of liquid fuel and air-vapor would be consistent with the allowable V/L at the fuel pump inlet, but instantaneously, the V/L would be above the average value part of the time and below average the rest of the time. The time in which the V/L is above average corresponds to an above-average bubble size, which, if it is large enough, would cause pump loss of prime and engine flame-out. When this problem occurs, the fuel feed system operating envelope in terms of altitude, fuel temperature, fuel system pressure drop, and aircraft g capability is reduced below the envelope that would be available based on the engine fuel pump's stated V/L capability.

Another possible cause of a momentary large amount of air-vapor at the engine fuel pump's fuel inlet is a natural bubble trap in the fuel line which can occur at some aircraft attitudes, but not at others. If the aircraft operates for a period of time at attitudes in which a large enough volume of air-vapor to cause fuel pump loss of priming is trapped at a local location in the fuel line and then the aircraft changes to an attitude at which the air-vapor is no longer trapped at that location, the large volume of air-vapor would suddenly travel all at once to the engine fuel pump inlet, possibly resulting in engine flame-out. This could occur even when the time-averaged V/L ratio is well within the allowable value for the engine fuel pump. Engine fuel feed lines with relatively long, near-horizontal sections can cause this situation.

For example, in a helicopter in which the fuel tank is located a significant distance forward of the engine it feeds, the fuel line section from the fuel tank to the cabin ceiling may be nearly vertical, followed by a long, near-horizontal fuel line section going aft to the engine. A natural fuel trap would occur in the corner between the vertical and horizontal fuel line segments when the aircraft is in a nose-up attitude, but not in a nose-down attitude. An air-vapor volume trapped in the corner while operating nose-up would quickly travel to the engine fuel pump inlet if the aircraft changes to a nose-down attitude.

One current approach to the bubble problem is to use a boost pump to pressurize the fuel line at conditions within the aircraft operating envelope where bubbles may be formed which are large enough to cause suction pump failure. Using a boost pump to pressurize the fuel line, however, negates the safety benefit of the suction system when the boost pump is operating.

### BRIEF SUMMARY

In one embodiment, a fuel feed system for a rotary-winged aircraft includes a fuel feed line extending from a fuel source to an engine and an engine fuel suction pump located at the fuel feed line to urge a flow of fuel through the fuel feed line to the engine. A collector is located along the fuel feed line between the fuel source and the engine to collect air-vapor which forms as bubbles in the flow of fuel. An air-vapor line extends from the collector and merges into the fuel line section between the collector and the engine fuel suction pump to flow the air-vapor captured in the collector to the engine fuel suction pump. The air-vapor line is sized and configured to limit the flow of air-vapor to the engine fuel suction pump to a flow rate that the engine fuel suction pump can tolerate.

In another embodiment, a rotary-winged aircraft includes an airframe and an engine located at the airframe, the engine operably connected to and driving a rotor assembly. A fuel feed system is operably connected to the engine and includes a fuel feed line extending from a fuel source to the engine. An engine fuel suction pump is located at the fuel feed line to urge a flow of fuel through the fuel feed line to the engine. A collector is located along the fuel feed line between the fuel source and the engine to collect air-vapor which forms as bubbles in the flow of fuel, and an air-vapor line extends from the collector to flow the air-vapor captured in the collector overboard or back to the fuel source such that the air-vapor does not enter the fuel line downstream of the collector and does not enter the engine fuel suction pump. An air pump in the air-vapor line urges the air-vapor captured in the collector to flow overboard or back to the fuel source via the air-vapor line.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic view of an embodiment of a helicopter;

FIG. 2 is a schematic view of an embodiment of a fuel feed system;

FIG. 3 is a schematic view of another embodiment of a fuel feed system; and

FIG. 4 is a schematic view of yet another embodiment of a fuel feed system.

The detailed description explains embodiments of the invention, together with advantages and features, by way of example with reference to the drawings.

### DETAILED DESCRIPTION

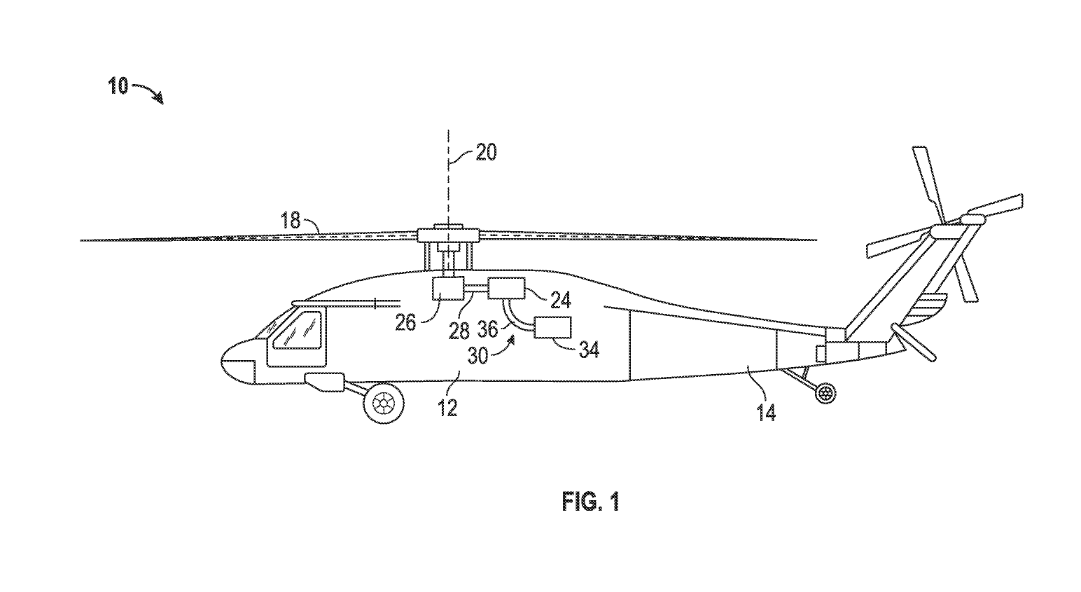

Shown in FIG. 1 is a schematic view of an embodiment of a rotary wing aircraft, in this embodiment a helicopter 10. The helicopter 10 includes an airframe 12 with an extending tail 14. A main rotor assembly 18 is located at the airframe 12 and rotates about a main rotor axis 20. The main rotor assembly 18 is driven by a power source, for example, an engine 24, in some embodiments, a turboshaft engine, via a gearbox 26. The engine 24 is connected to the gearbox 26 via a drive shaft 28. A fuel feed system 30 provides fuel to the engine 24.

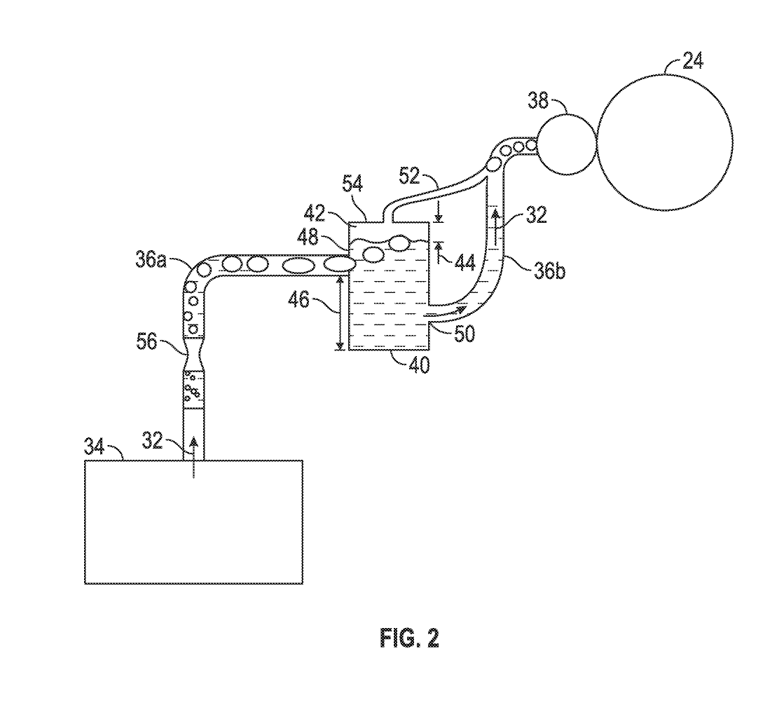

Referring now to FIG. 2, the fuel feed system 30 will be described in more detail. A flow of fuel 32 is drawn from a fuel tank 34 through a fuel line 36 toward the engine 24 via an engine fuel pump 38. The engine fuel pump 38 is a suction pump. Use of a suction pump ensures that the fuel line 36 is not pressurized during operation of the engine fuel pump 38, such that a rupture or failure of the fuel line 36 will result in air being drawn into the fuel line 36 rather than fuel being sprayed from the fuel line 36.

A chamber, bubble collector 40, is located along the fuel line 36, between a lower fuel line 36a and an upper fuel line 36b. The lower fuel line 36a extends from the fuel tank 34 to the bubble collector 40, while the upper fuel line 36b extends from the bubble collector 40 to the engine fuel pump 38. The bubble collector 40 collects air-vapor 42 that separates from the flow of fuel 32 due to operation of the engine fuel pump 38. The air-vapor 42 collects in an upper portion 44 of the bubble collector 40, while the flow of fuel 32 proceeds through a lower portion 46 of the bubble collector 40 toward the engine 24 via the upper fuel line 36b. The bubble collector 40 includes a collector inlet 48 from the lower fuel line 36a and a collector outlet 50 to the upper fuel line 36b, with the collector outlet 50 located below the collector inlet 48 to facilitate separation of the air-vapor 42 from the flow of fuel 32.

The bubble collector 40 can be sized to capture the largest single local accumulation of air-vapor 42 which can occur in the lower fuel line 36a. The air-vapor 42 collected from one large accumulation can then be removed from the bubble collector 40 to make room for the next one.

In some embodiments, as shown in FIG. 2, the air-vapor 42 is reintroduced into the upper fuel line 36b. An air-vapor line 52 extends from the upper portion 44 of the bubble collector 40 and merges with the upper fuel line 36b. In some embodiments, the air-vapor line 52 extends from a top surface 54 of the bubble collector 40. Air-vapor 42 captured in the upper portion 44 of the bubble collector 40 is drawn by the engine fuel pump 38 in parallel with the flow of fuel 32 in the upper fuel line 36b. The air-vapor line 52 can be sized and configured to limit the rate of re-introduction of captured air-vapor back into the fuel entering the engine fuel pump 38 to a value that the engine fuel pump 38 can tolerate. This approach effectively reduces the amplitude of the instantaneous V/L ratio of the fuel 32 entering the engine fuel pump 38 from the time-averaged value to a level that the engine fuel pump 38 can tolerate. Provided that the pressure drop vs. fuel flow of the entire fuel feed system from the fuel tank 34 and the engine fuel pump 38 is consistent with the time-averaged V/L limit of the engine fuel pump 38, the bubble collector 40 would likely not fill with air-vapor 42 to the point where significant amounts of air-vapor bubbles 42 exit the bubble collector 40 directly via the upper fuel line 36b. For operating conditions in which large accumulations of air-vapor 42 do not occur anywhere in the fuel line 36a or 36b, the vapor line 52 could simply function as a parallel path for the flow of fuel 32 when air-vapor 42 is not present. To ensure that air-vapor in the bubble collector 40 is drawn out of the bubble collector 40 toward the engine fuel pump 38, the upper portion 44 of the bubble collector 40 is positioned below the engine fuel pump 38 to provide a natural upward flowpath for the air-vapor. The upper portion of the bubble collector 44 is also positioned below the point where the air-vapor line 52 merges with the upper fuel line 36b, resulting in a pressure differential due to the head (difference in height) between the merge of the air-vapor line 52 into the upper fuel line 36b and the fuel level in the bubble collector 40 which draws the air-vapor out of the upper bubble collector 44.

Further, in some embodiments, the lower fuel line 36a includes a smooth venturi 56, or a smooth narrowing 56 in the lower fuel line 36a, to locally reduce the static pressure in the lower fuel line 36a, thereby encouraging additional air-vapor 42 formation without significantly increasing the overall total pressure drop versus fuel flow of the fuel feed system between the fuel tank 34 and the engine fuel pump 38. The venturi/reduced flow area 56 is included in the lower fuel line 36a to extract additional air-vapor 42 from the flow of fuel 32 upstream of the bubble collector 40, thereby increasing an amount of air-vapor 42 removed from the flow of fuel 32 at the bubble collector 40. The venturi/reduced flow area 56 is positioned close enough to the bubble collector 40 such that the additional air-vapor 42 formed by the venturi/reduced flow area 56 does not return to solution in the flow of fuel 32 prior to entering the bubble collector 40. The purpose of extracting additional air from the fuel upstream of the bubble collector 40 is to provide additional flexibility in the location of the bubble collector 40 between the fuel tank 34 and the engine pump 38 in a bubble collector 40 configuration in which the air-vapor line 52 merges with the upper fuel line 36b. Removing additional air-vapor from the fuel line 36a allows the bubble collector 40 to be located closer to the fuel tank 34 and at a lower height than would be needed without the venturi/area reduction 56.

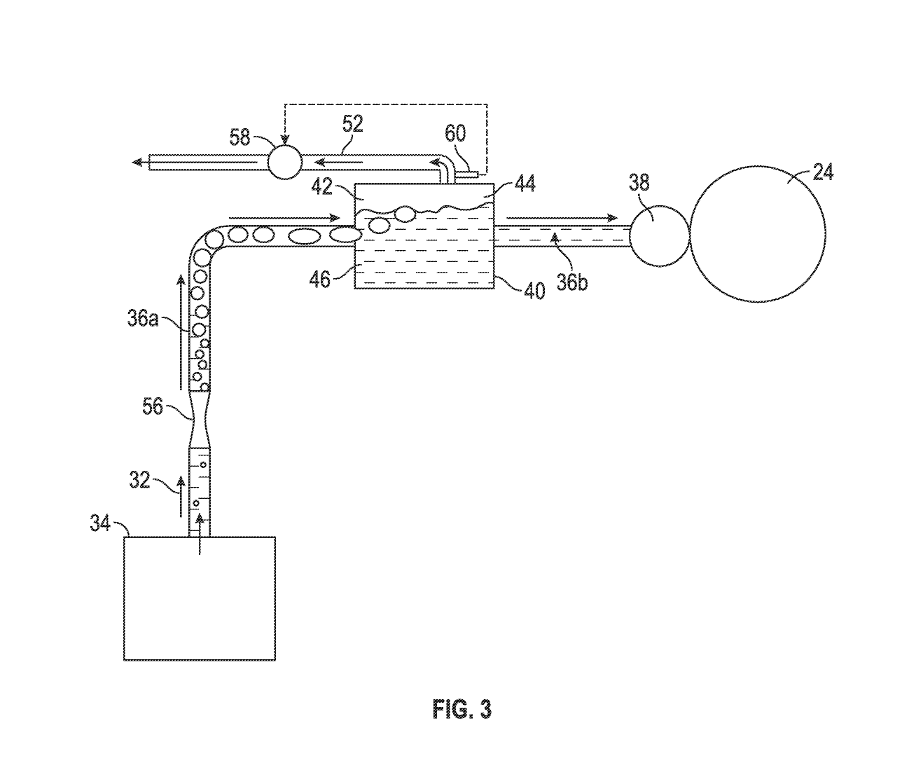

In another embodiment, as shown in FIG. 3, the air-vapor 42 captured in the collector 40 is not reintroduced into the upper fuel line 36b. An air pump 58, in some embodiments a positive displacement pump, is used to pump the air-vapor 42 from the bubble collector 40 through the vapor line 52, which, in this embodiment, returns the air-vapor 42 to the fuel tank 34 (not shown). Alternatively, the air pump 58 may pump the air-vapor 42 overboard via the vapor line 52. Under some operating conditions, when there is not a significant amount of air-vapor 42 in the bubble collector 40, it is desired not to operate the air pump 58. Thus, a fuel sensor 60 is placed at an entrance to the vapor line 52. When the fuel sensor 60 is covered by fuel, as when there is not a significant amount of air-vapor 42 in the bubble collector 40, the air pump 58 is turned off. When the fuel sensor 60 is not covered by fuel, indicating presence of air-vapor 42, the air pump 58 is turned on and the air-vapor 42 is pumped from the bubble collector 40. This feature prevents pumping liquid fuel overboard under most circumstances. The air pump 58 should be tolerant of exposure to fuel and be capable of pumping liquid fuel in the event some liquid fuel momentarily reaches the pump due to maneuvering, fuel sloshing, etc. Use of a venturi/area reduction 56 in the lower fuel line 36a with a bubble collector 40 in which the air-vapor 42 is pumped back to the fuel tank 34 or overboard would remove more air-vapor 42 from the fuel than would be the case without the venturi/area reduction; less air-vapor 42 would reach the engine fuel pump 38.

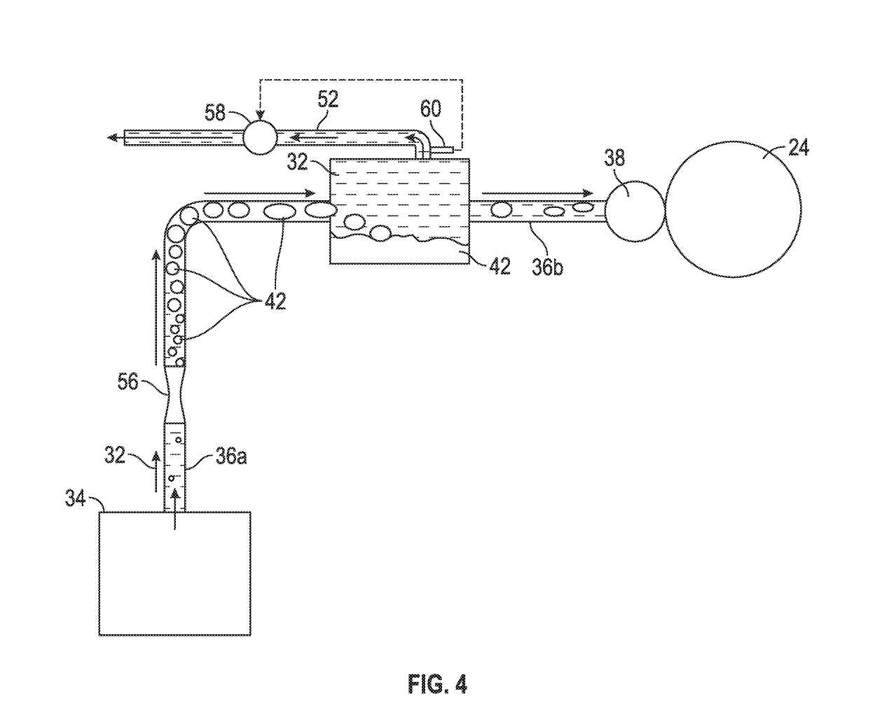

Referring now to FIG. 4, extending the bubble collector 40 volume below the level of the fuel line 36a entry into and 36b exit out of the bubble collector 40 provides a negative g capability. The bubble collector 40 volume below the fuel line 36b level at the collector 40 outlet provides a space for any air-vapor 42 accumulated in the upper portion 44 of the bubble collector 40 prior to the negative g maneuver to go to during the negative g maneuver without significant amounts of the air-vapor 42 getting into the upper fuel line 36b. A small portion of the air-vapor 42 in the bubble collector 40 would be expected to enter the upper fuel line 36b while the collected air-vapor 42 is transitioning from the upper portion 44 of the bubble collector 40 to the lower portion 46 during the negative g maneuver and back to the upper portion 44 again after the negative g maneuver is over.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel feed system for a rotary-winged aircraft comprising:
a fuel feed line extending from a fuel source to an engine;
an engine fuel suction pump disposed at the fuel feed line to urge a flow of fuel through the fuel feed line to the engine;
a collector disposed along the fuel feed line between the fuel source and the engine to collect air-vapor in the flow of fuel; and
an air-vapor line extending from the collector to flow the air-vapor from the collector sized and configured to limit a maximum rate of air-vapor reaching the engine fuel suction pump.

2. The fuel feed system of claim 1, wherein the air-vapor is reintroduced at a reduced maximum rate into the fuel feed line between the collector and the engine fuel suction pump.

3. The fuel feed system of claim 2, wherein a vapor line exit from the collector is positioned vertically below the pump and vertically below a merge of the air-vapor line into an upper portion of the fuel feed line.

4. The fuel feed system of claim 1 wherein a fuel line exit from the collector is vertically below the pump and vertically below a merge of the air-vapor line into an upper portion of the fuel feed line.

5. The fuel feed system of claim 1, further comprising a smooth local narrowing of the fuel feed line at a location between the fuel source and the collector configured to induce additional air-vapor formation in the fuel feed line.

6. The fuel feed system of claim 1, including an air pump in the air-vapor line to urge air-vapor from the collector into the air-vapor line.

7. The fuel feed system of claim 6, wherein the air-vapor is routed to the fuel source via the air-vapor line.

8. The fuel feed system of claim 6, wherein the air-vapor is removed from the fuel feed system via the air-vapor line.

9. The fuel feed system of claim 6 further comprising a fuel sensor in or at an entrance to the air-vapor line configured to control operation of the air pump.

10. A rotary-winged aircraft comprising:
an airframe;
an engine disposed at the airframe, the engine operably connected to and driving a rotor assembly; and
a fuel feed system operably connected to the engine including:
a fuel feed line extending from a fuel source to the engine;
an engine fuel suction pump disposed at the fuel feed line to urge a flow of fuel through the fuel feed line to the engine;
a collector disposed along the fuel feed line between the fuel source and the engine to collect air-vapor in the flow of fuel; and
an air-vapor line extending from the collector to flow the air-vapor from the collector sized and configured to limit a maximum rate of air-vapor reaching the engine fuel suction pump.

11. The aircraft of claim 10, wherein the air-vapor is reintroduced into the fuel feed line between the collector and the engine fuel suction pump.

12. The aircraft of claim 11, wherein an air-vapor line exit from the collector is positioned vertically below the pump and vertically below a merge of the air-vapor line into an upper fuel line.

13. The aircraft of claim 10, wherein a fuel line exit from the collector is vertically below the pump and vertically below a merge of the air-vapor line into an upper fuel line.

14. The aircraft of claim 10, further comprising a smooth local narrowing of the fuel feed line at a location between the fuel source and the collector configured to induce additional air-vapor formation in the fuel feed line.

15. The aircraft of claim 10, including an air pump in the air-vapor line to urge air-vapor from the collector into the air-vapor line.

16. The aircraft of claim 15, wherein the air-vapor is routed to the fuel source or overboard via the air-vapor line.

17. The aircraft of claim 15, wherein the air-vapor is removed from the fuel feed system via the air-vapor line.

18. The aircraft of claim 15, further comprising a fuel sensor at the air-vapor line configured to control operation of the air pump.
